(19) United States
(12) Patent Application Publication
(10) Pub. No.: US 2017/0014925 A1
(43) Pub. Date: Jan. 19, 2017

(54) Rethreader die

(71) Applicant: A & E INCORPORATED, Racine, WI (US)

(72) Inventors: Timothy J. Alho, Pleasant Prairie, WI (US); Mark Brunner, West Allis, WI (US)

(73) Assignee: A & E INCORPORATED, Racine, WI (US)

(21) Appl. No.: 14/998,073

(22) Filed: Dec. 24, 2015

Related U.S. Application Data
(60) Provisional application No. 62/096,591, filed on Dec. 24, 2014.

(51) Int. Cl. B23G 9/00

(52) U.S. Cl. CPC B23G 9/009; B23G 2200/06

(57) ABSTRACT

A split re-threading die includes two halves pivotally attached to each other and defining a through-bore and a hexagonal external surface when closed. Each half has inward facing teeth at the free end. The through-bore is configured to receive an externally threaded fastener to be re-threaded and the hexagonal external surface is configured to be received within a mechanical socket. The teeth rethread the fastener as the die is turned and the teeth traverse the threads of the fastener.

### RELATED APPLICATIONS

This application claims the benefit of co-pending U.S. provisional patent application Ser. No. 62/096,591, filed on 24 Dec. 2014.

### BACKGROUND OF THE INVENTION

It has happened to everyone. A nut is cross-threaded on a bolt and ruins the threads or the threads are damaged in some other way, for example, by exposure to the elements. In order for the bolt to be once again usable, the bolt must be rethreaded with a rethreader die.

Rethreader dies are well known in the art. Many rethreader operations require starting the die at the end of the bolt and threading in a direction towards the head of the bolt. This works well when there are good threads at the end on which to start the rethreader die, but may not work well when the damaged threads are located at the end of the bolt. When this is the case, a split rethreader die is a preferred device to be used as it is able to start at a point where there are good threads.

Split rethreader dies, however, may come in multiple pieces that are easy to lose or assemblies that are cumbersome to place about the bolt accurately. Accordingly, the art of split rethreader dies could benefit from a single assembly device capable of accurate placement on any part of a bolt.

### SUMMARY OF THE INVENTION

The present invention relates to a rethreader die, and more particularly to a single assembly split rethreader die capable of accurate placement on a bolt at any location having good threads.

One aspect of the present invention provides a rethreader die having a first half pivotally connected to a second half at a joint; the first half and the second half combining to define a through-bore, a socket engagement portion, and a thread engagement portion; the joint located opposite the thread engagement portion; the socket engagement portion having a socket engagement portion outer surface configured to be received within a mechanical socket; and the thread engagement portion having at least one set of teeth extending inward from the through-bore and configured to engage the threads of a threaded fastener.

The socket engagement portion outer surface may taper at a taper angle from the thread engagement portion through the socket engagement portion, and the taper angle may be in the range from about 0 degrees to about 15 degrees or in the range from about 0 degrees to about 10 degrees or in the range from about 0 degrees to about 5 degrees.

The joint may have a first half knuckle overlapping a second half knuckle and a pin securing the first half knuckle and the second half knuckle together.

Additionally or alternatively, the joint may have a cross-member attached to each of the first half and the second half with a pin and may provide that the cross-member and pins are set within a recess in the first and second halves. A relief may be provided in the first half and the second half near the joint, the relief has a relief angle provided between the first half and the second half when the rethreader die is in a rethreading position. The relief angle may be in the range from about 15 degrees to about 45 degrees or in the range from about 25 degrees to about 35 degrees or about 30 degrees.

Another aspect of the present invention provides a method for repairing a threaded fastener with damaged threads and undamaged threads, including the steps of: providing a rethreader die having a first half pivotally connected to a second half at a joint; the first half and the second half combining to define a through-bore, a socket engagement portion, and a thread engagement portion; the joint located opposite the thread engagement portion; the socket engagement portion having a socket engagement portion outer surface configured to be received within a mechanical socket; and the thread engagement portion having at least one set of teeth extending inward from the through-bore and configured to engage the threads of a threaded fastener; opening the rethreader die by pivoting the first half and the second half away from each other about the pivot; receiving the fastener within the through-bore; closing the rethreader die around the fastener and engaging the at least one set of teeth with the undamaged threads; and rotating the rethreader die in a direction towards and through the damaged threads.

Additionally or alternatively, the socket engagement portion outer surface of the rethreader die may taper at a taper angle from the thread engagement portion through the socket engagement portion. If this is the case the method may also include the steps of providing a mechanical socket sized to impart a circumferential force on the rethreader die when the socket engagement portion is substantially received within the mechanical socket; placing the mechanical socket around the rethreader die; and imparting a circumferential force from the mechanical socket through the at least one set of teeth of the rethreader die to the threaded fastener.

### BRIEF DESCRIPTION OF THE DRAWINGS

FIG. 1 is a perspective view of a first embodiment of a split rethreader die according to the present invention.

FIG. 2 is an exploded view of the die shown in FIG. 1.

FIG. 3 is a top view of the die shown in FIG. 1.

FIG. 4 is a side view of the die shown in FIG. 1.

FIG. 5 is a cross-sectional view of the die along line 5-5 of FIG. 3.

FIG. 6 is a bottom view of the die shown in FIG. 1.

FIG. 7 is a perspective view of the die shown in FIG. 1 received within a mechanical socket.

FIG. 8 is a perspective view of a second embodiment of a split rethreader die according to the present invention received within a mechanical socket.

FIG. 9 is a side view of the die shown in FIG. 8 received within a mechanical socket.

FIG. 10 is a top view of a third embodiment of a split rethreader die according to the present invention.

FIG. 11 is a side view of the die shown in FIG. 10.

FIGS. 12-14 illustrate a method of using the first embodiment of the split rethreader die to rethread an external threaded fastener according to the present invention.

FIG. 15 is a side view of a rethreaded fastener.

### DESCRIPTION OF THE PREFERRED EMBODIMENT

Although the disclosure hereof is detailed and exact to enable those skilled in the art to practice the invention, the physical embodiments herein disclosed merely exemplify the invention which may be embodied in other specific structures. While the preferred embodiment has been described, the details may be changed without departing from the invention, which is defined by the claims.

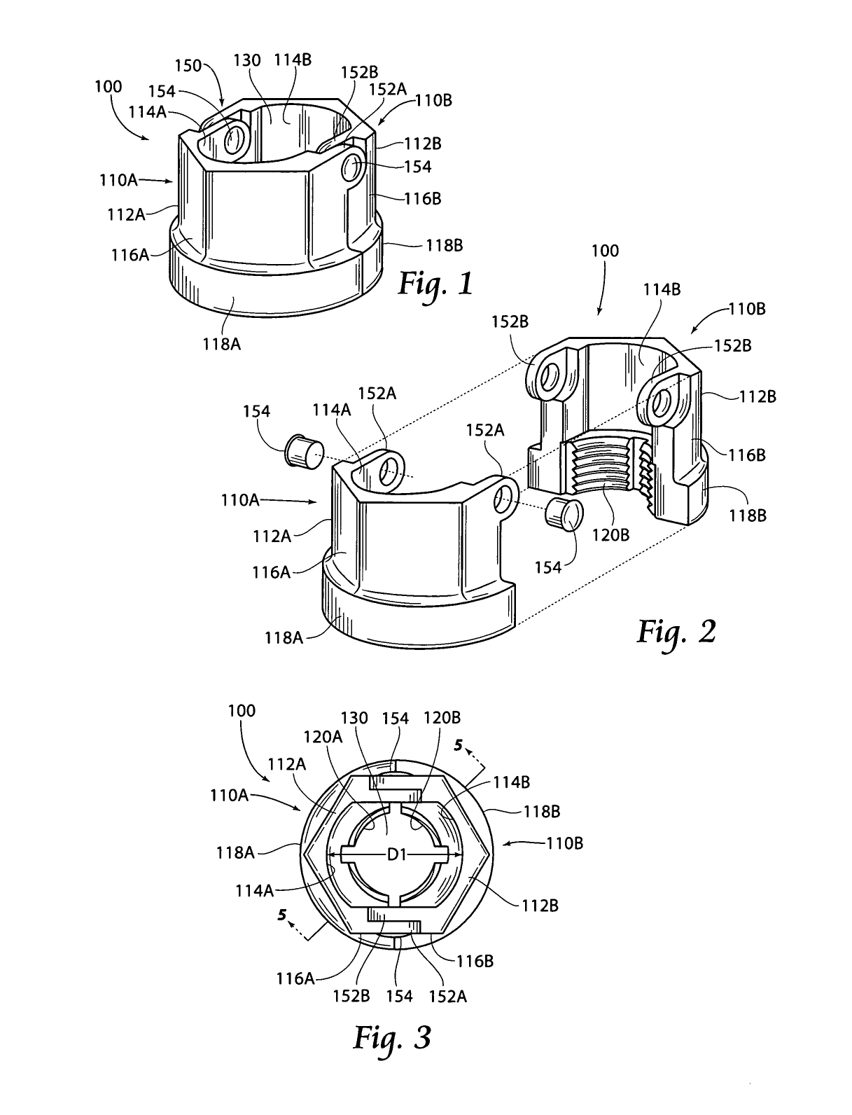

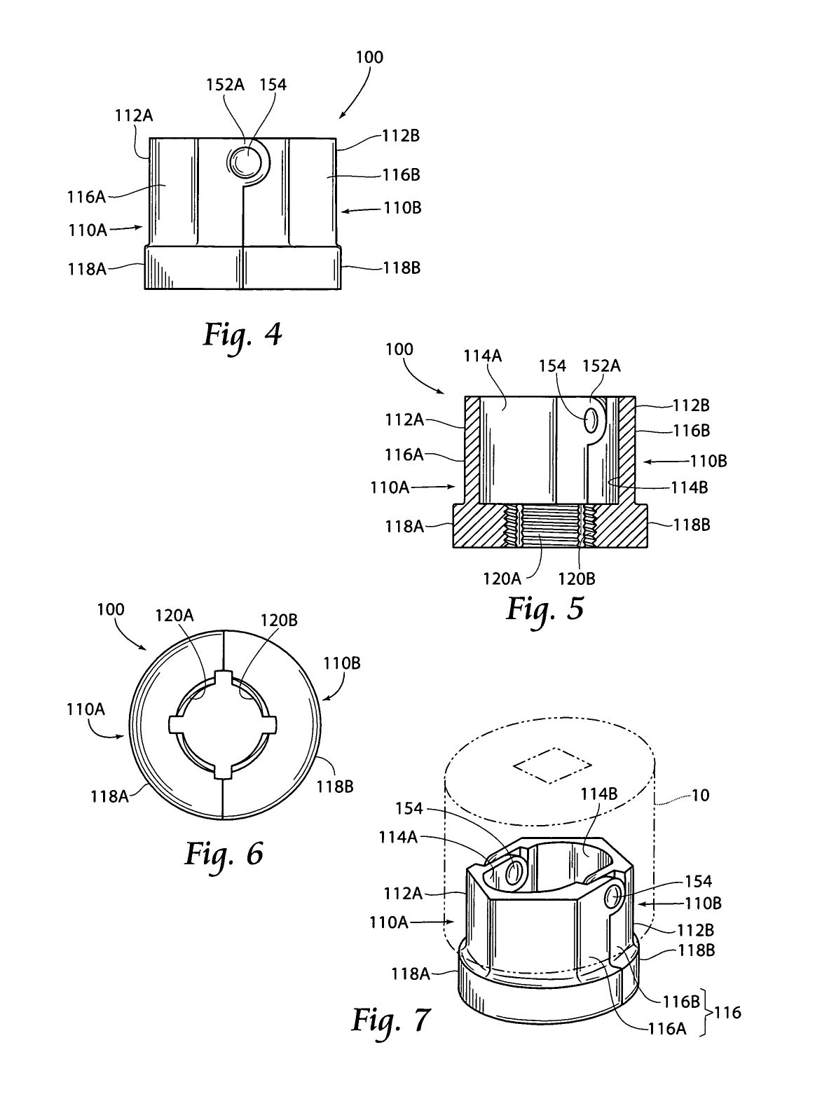

FIG. 1 illustrates a first embodiment 100 of the split rethreader die. The split rethreader die 100 comprises a first half 110A and a second half 110B.

Preferably the first half 110A and the second half 110B are substantially identical.

The first and second halves 110A, 110B preferably have a substantially semi-circular profile and each comprise a socket engagement portion 112A, 112B and a thread engagement portion 118A, 118B. When combined, the first and second halves 110A, 110B have a substantially circular through-bore 130 extending from the socket engagement portions 112A, 112B through the thread engagement portions 118A, 118B.

The socket engagement portions 112A, 112B each have an inside surface 114A, 114B along the through-bore 130 and an outside surface 116A, 116B. The joined combination of the outside surfaces 116A, 116B is configured to emulate the inside of a the operating end of a wrench-type hand tool (i.e., a box end wrench, an open end wrench, a crescent wrench, a mechanical socket 10 as shown in FIG. 7, and other similar tools as are known in the art). As shown here, for example, the socket engagement portion outside surfaces 116A, 116B combine to define a hexagonal socket engagement portion outer surface 116 (see FIG. 7).

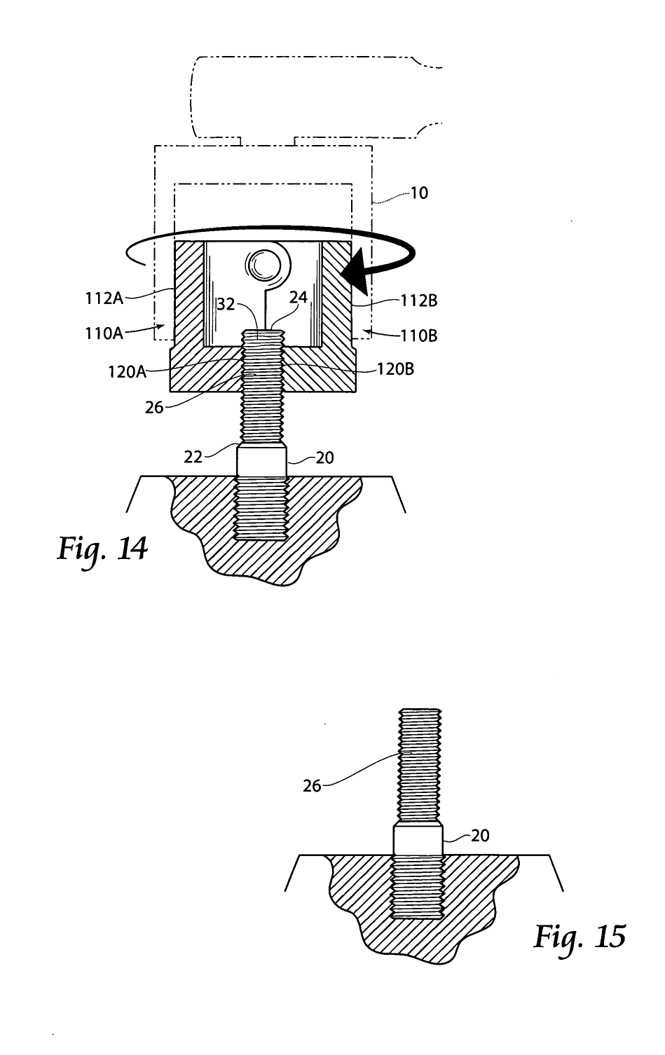

The portion of the through-bore 130 in the combined socket engagement portions 112A, 112B provides a pocket 140, whereby the pocket 140 has a first diameter D1. The first diameter D1 is at least as wide as the diameter D2 of the peaks 28 of external threads 26 of an external threaded fastener 20 (see FIG. 14) to be re-threaded.

The thread engagement portions 118A, 118B each preferably have at least one set of teeth 120A, 120B extending inward from the through-bore 130. The at least one set of teeth 120A, 120B are configured to align with the valleys 30 of the external threads 26 of the external threaded fastener 20 (see FIG. 14) to be rethreaded.

As shown in FIG. 2, the first and second half thread engagement portion at least partially overlap with the first and second half socket engagement portion.

The first and second halves 110A, 110B are pivotally attached to one another at joints 150 on the socket engagement portions 112A, 112B. The joints 150 preferably comprise interfacing knuckles 152A, 152B of the first and second halves 110A, 110B, respectively, secured together by pins or rivets 154; however, any means of pivotally connecting the first and second halves 110A, 110B which does not interfere with insertion of the die 100 into a mechanical socket 10 (see FIG. 15) or the through-bore's 130 reception of an external threaded fastener 20 (see FIG. 15), are contemplated herein.

For example, a third embodiment 300 of a split rethreader die according to the present invention, wherein similar numbers represent similar elements, is provided in FIGS. 10 and 11. The split rethreader die 300 has a first half 310A connected to a second half 310B wherein the joint 350 comprises a pair of cross-members 324. Each cross-member 324 is attached to the first half 310A and the second half 310B by a pair of pins 354.

A recess 322 is preferably provided in the first and second halves 310A,310B to house the cross-members 324 and pins 354 so as limit interference with a mechanical socket 10. As the first and second halves 310A,310B do not rotate about the same axis, reliefs 326 are provided near the joints 350 to allow for rotation of the first and second halves 310A,310B about the respective pins 354. The reliefs 354 are configured between the first half and the second half at an angle α when the first and second halves 310A,310B are in a rethreading position (as depicted in FIG. 11). Preferably angle α is in the range from about 15 degrees to about 45 degrees, more preferably from about 25 degrees to about 35 degrees, more preferably angle α is about 30 degrees.

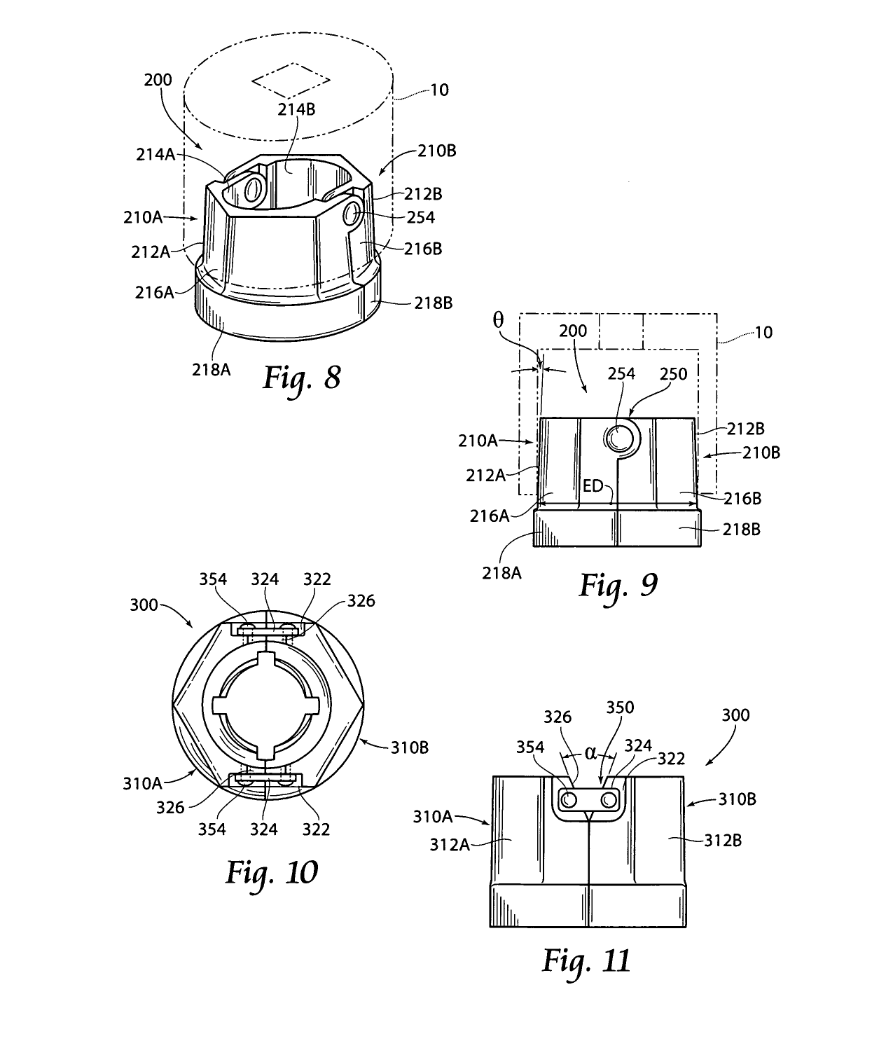

FIGS. 8 and 9 illustrate a second embodiment 200 of a split rethreader die according to the present invention, wherein similar numbers represent similar elements. The split rethreader die 200 comprises tapered outside surfaces 216A, 216B on the socket engagement portions 212A, 212B. The first and second half socket engagement sections 212A, 212B have a combined exterior dimension ED at or near the first and second half threaded engagement portions 218A, 218B (hidden) from which the first and second half socket engagement section outside surfaces 216A, 216B taper inward at a taper angle θ in the direction of the joints 250.

The exterior dimension ED is preferably larger in dimension than the socket size of the mechanical socket 10 to be used in conjunction with the rethreader die 200. The taper angle θ is preferably in the range of about 0 degrees to about 15 degrees, more preferably in the range of about 0 degrees to about 10 degrees, more preferably in the range of about 0 degrees to about 5 degrees. When in use, the mechanical socket 10 preferably imparts a circumferential force on the rethreader die 200 when the socket engagement portions 212A,212B are substantially received within the mechanical socket 10 and the circumferential force is transferred through the teeth 220A,220B (hidden) to the threaded fastener 20.

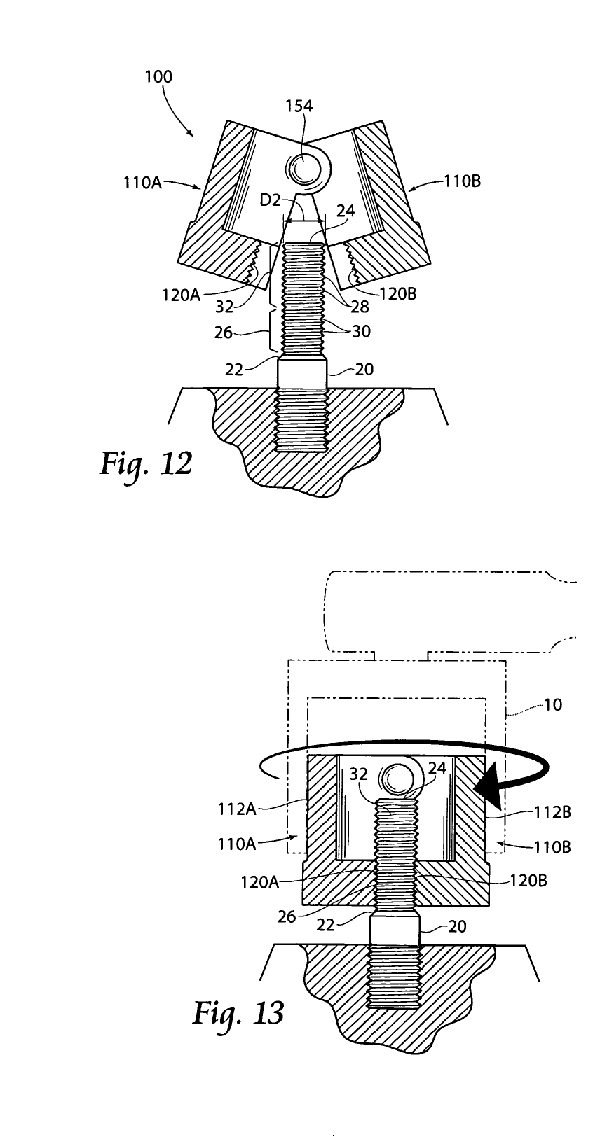

A method for rethreader an external threaded fastener 20 with undamaged threads 26, damaged threads 32, a proximal end 22, and a distal end 24 is shown in FIGS. 12-14. FIG. 12 shows the two halves 110A, 110B of the die 100 pivoted away from each other about pivot 154. Looking to FIG. 15, the fastener 20 is shown placed within the die 100 with the two halves 110A, 110B brought together around the fastener 20 with the teeth 120A, 120B positioned within the fastener valleys 30 of undamaged threads 26 between the damaged threads 32 and the proximal end 22. The socket engagement portions 212A, 212B are received within a mechanical socket 10, then the mechanical socket 10, along with the die 100, are turned to move along the undamaged threads 26 of the fastener 20 in the direction of the damaged threads 32 (here the die 100 is turned counter-clockwise as the fastener 20 has right-hand threads and the teeth 120A, 120B are placed on the proximal side of the damaged threads 32).

FIG. 14 illustrates the teeth 120A, 120B repairing the damaged threads 32 as the die 100 continues to rotate about the fastener 20 until the teeth 120A, 120B reach undamaged threads 26 on the distal side of the damaged threads 32 (not depicted here) or the distal end 24 of the fastener 20.

The die 100 is removed from the mechanical socket 10 and the fastener 20 to leave a re-threaded fastener 20 as shown in FIG. 15.

The foregoing is considered as illustrative only of the principles of the invention. Furthermore, since numerous modifications and changes will readily occur to those skilled in the art, it is not desired to limit the invention to the exact construction and operation shown and described. While the preferred embodiment has been described, the details may be changed without departing from the invention, which is defined by the claims.

We claim:

1. A rethreader die comprising:
a first half pivotally connected to a second half at a joint;
the first half and the second half combining to define a through-bore, a socket engagement portion, and a thread engagement portion;
the joint located opposite the thread engagement portion;
the socket engagement portion having a socket engagement portion outer surface configured to be received within a mechanical socket; and
the thread engagement portion having at least one set of teeth extending inward from the through-bore and configured to engage the threads of a threaded fastener.

2. The rethreader die of claim 1, wherein the socket engagement portion outer surface tapers at a taper angle from the thread engagement portion through the socket engagement portion.

3. The rethreader die of claim 2, wherein the taper angle is in the range from about 0 degrees to about 15 degrees.

4. The rethreader die of claim 2, wherein the taper angle is in the range from about 0 degrees to about 10 degrees.

5. The rethreader die of claim 2, wherein the taper angle is in the range from about 0 degrees to about 5 degrees.

6. The rethreader die of claim 1, wherein the joint comprises a first half knuckle overlapping a second half knuckle and a pin securing the first half knuckle and the second half knuckle together.

7. The rethreader die of claim 1, wherein the joint comprises a cross-member attached to each of the first half and the second half with a pin.

8. The rethreader die of claim 7, wherein the cross-member and pins are set within a recess in the first and second halves.

9. The rethreader die of claim 7, wherein a relief is provided in the first half and the second half near the joint, the relief has a relief angle provided between the first half and the second half when the rethreader die is in a rethreading position.

10. The rethreader die of claim 9, wherein the relief angle is in the range from about 15 degrees to about 45 degrees.

11. The rethreader die of claim 9, wherein the relief angle in the range from about 25 degrees to about 35 degrees.

12. The rethreader die of claim 9, wherein the relief angle is about 30 degrees.

13. A method for repairing a threaded fastener with damaged threads and undamaged threads, the method comprising the steps of:
providing a rethreader die comprising:
a first half pivotally connected to a second half at a joint;
the first half and the second half combining to define a through-bore, a socket engagement portion, and a thread engagement portion;
the joint located opposite the thread engagement portion;
the socket engagement portion having a socket engagement portion outer surface configured to be received within a mechanical socket; and
the thread engagement portion having at least one set of teeth extending inward from the through-bore and configured to engage the threads of a threaded fastener;
opening the rethreader die by pivoting the first half and the second half away from each other about the pivot;
receiving the fastener within the through-bore;
closing the rethreader die around the fastener and engaging the at least one set of teeth with the undamaged threads; and
rotating the rethreader die in a direction towards and through the damaged threads.

14. The method of claim 13, wherein the socket engagement portion outer surface of the rethreader die tapers at a taper angle from the thread engagement portion through the socket engagement portion.

15. The method of claim 14, further comprising the steps of:
providing a mechanical socket sized to impart a circumferential force on the rethreader die when the socket engagement portion is substantially received within the mechanical socket;
placing the mechanical socket around the rethreader die; and
imparting a circumferential force from the mechanical socket through the at least one set of teeth of the rethreader die to the threaded fastener.
